(19) United States
(12) Patent Application Publication
(10) Pub. No.: US 2022/0384072 A1
(43) Pub. Date: Dec. 1, 2022

(54) RARE EARTH SINTERED MAGNET AND MAKING METHOD

(71) Applicant: SHIN-ETSU CHEMICAL CO., LTD., Tokyo (JP)

(72) Inventors: Akihiro YOSHINARI, Echizen-shi (JP); Koichi HIROTA, Echizen-shi (JP)

(73) Assignee: SHIN-ETSU CHEMICAL CO., LTD., Tokyo (JP)

(21) Appl. No.: 17/741,843

(22) Filed: May 11, 2022

(30) Foreign Application Priority Data
May 12, 2021 (JP) 2021-080801

(51) Int. Cl. H01F 1/057; H01F 41/02; C22C 38/00; C22C 38/32

(52) U.S. Cl. CPC H01F 1/0577; H01F 41/0293; C22C 38/001; C22C 38/005; C22C 38/32

(57) ABSTRACT

A rare earth sintered magnet has a C concentration of 800-1,400 ppm, an O concentration of up to 1,000 ppm, and a N concentration of up to 800 ppm, an average crystal grain size D50 of up to 4.5 μm, and a degree of orientation Or (%) which is defined by the formula: Or (Br/4πIs)*100, wherein D50 and Or meet the relationship: Or>0.7*D50+95. The sintered magnet shows both high values of Br and H_{cJ}.

### CROSS-REFERENCE TO RELATED APPLICATION

This non-provisional application claims priority under 35 U.S.C. § 119(a) on Patent Application No. 2021-080801 filed in Japan on May 12, 2021, the entire contents of which are hereby incorporated by reference.

### TECHNICAL FIELD

This invention relates to a rare earth sintered magnet having a high remanence and stable coercivity and a method for preparing the same.

### BACKGROUND ART

R—Fe—B sintered magnets, typically Nd-based sintered magnets constitute a class of functional material which is essential for energy saving and greater functional performance. Their application range and production quantity are annually expanding. They are used, for example, in drive motors in hybrid cars and electric vehicles, motors in electric power steering systems, motors in air conditioner compressors, and voice coil motors (VCM) in hard disk drives. While the high remanence (or residual magnetic flux density) Br of R—Fe—B magnets is a great advantage in these applications, such magnets having higher Br are desired for further size reduction of motors or the like.

The Br of R—Fe—B sintered magnet can be enhanced by increasing the proportion of R₂Fe₁₄B phase in the sintered magnet. For this purpose, means of reducing the content of R while reducing impurities as typified by oxygen, carbon and nitrogen, and means of increasing the degree of orientation of R₂Fe₁₄B phase are known effective.

One known means of increasing the degree of orientation of R₂Fe₁₄B phase as main phase is to increase the amount of a lubricant added during fine pulverization. This means is also effective for restraining nitridation. When a large amount of lubricant is added, however, there arise problems such as inefficient shaping and a drop of coercivity (H_{cJ}) due to the increased amount of carbon left after sintering. It is desired for a limited amount of the lubricant to exert more effects in terms of orientation and shaping. It has been proposed to select an appropriate lubricant from various substances, typically organic compounds.

For example, Patent Document 1 discloses the use of a lubricant selected from solid paraffins and camphor to impart good lubricity for reducing the friction between the die surface and a compact (shaped body) during shaping for thereby avoiding flaws, stripping or crack on the compact surface.

Patent Document 2 discloses a lubricant in the form of a solid which sublimates at room temperature. By adding the lubricant to a coarsely ground alloy powder and finely pulverizing the powder, there is obtained a fine powder having free flowing properties because fine particles are covered with the lubricant so that formation of an oxide coating is restrained.

Patent Document 3 describes a sintered magnet of specific composition having a fine structure with a crystal grain size of up to 3.5 μm and a high degree of orientation. The method for preparing the sintered magnet includes the step of nitriding a starting powder and omits the compression shaping step.

### CITATION LIST

Patent Document 1: JP-A H04-214804
Patent Document 2: JP-A 2002-285208
Patent Document 3: JP-A 2020-031145

### SUMMARY OF INVENTION

While Patent Documents 1 and 2 describe the choice of an appropriate lubricant, the influence of the lubricant on Br is referred to nowhere.

In Patent Document 1, the lubricant is selected for the purposes of reducing compact withdrawal pressure to prevent a compact from cracking or chipping and increasing the product manufacture yield. The compressed powder density is as high as 4.4 g/cm³ or greater. It is expected that the high shaping pressure causes disordering of orientation, which is against the acquisition of higher Br.

In Patent Document 2, fine particles are surface-coated with a sublimatable lubricant, obtaining an effect of preventing the fine particles from oxidation. Although the oxygen content is prescribed, no reference is made to the influence on nitrogen concentration by fine pulverization a low-oxygen, low-moisture environment. The object is contradictory to the acquisition of both high Br and H_{cJ}. When a normally solid, sublimatable compound is added as the lubricant to a powder in the jet mill system, the concentration of the lubricant in the system rises during the continuous manufacturing process. There are risks that the lubricant precipitates at a relatively cold section of the conduit, causing clogging and that the carbon concentration increases unintentionally. Thus a need to monitor the concentration of lubricant gas in the system arises on the installation side.

In Patent Document 3, a raw material powder is dispersed in nitrogen gas for a certain time for the nitriding purpose in order to acquire both a high degree of orientation and fine crystal grains. With the aim to gain high Br, R is effectively distributed along the grain boundary while reducing the R content. Then the need to gain H j by minimizing the content of nitrogen that is an impurity capable of forming a compound phase with R remains unsolved.

The method of producing a magnet with high Br by reducing the R content while reducing impurities as typified by oxygen, carbon and nitrogen has the problem that a drop of coercivity occurs as a result of nitrogen concentration increasing in association with a lowering of oxygen concentration. An attempt to reduce the size of crystal grains to compensate for a drop of H_{cJ} caused by the reduced R content (for enhancing Br) invites the progress of nitriding, which is detrimental to a degree of orientation.

An object of the invention is to provide a rare earth sintered magnet of R—Fe—B system containing microscopic crystal grains, the magnet being of quality in that it maintains a low nitrogen concentration despite a low oxygen concentration and a high degree of orientation, and exhibits high Br and stable H_{cJ}.

The inventors have found that a rare earth sintered magnet having high values of Br and H_{cJ} is obtained by adjusting the concentrations of carbon, oxygen and nitrogen to specific values, adjusting an average crystal grain size D50 in a plane parallel to the magnetization direction, and optimizing the relationship of D50 to a degree of orientation Or. In conjunction with a method for producing a rare earth sintered magnet through the steps of finely pulverizing a coarsely ground powder of an alloy containing R, Fe and B into a fine powder and compacting the fine powder into a magnet, a rare earth sintered magnet having high values of Br and H_{cJ} is produced by optimizing the type of lubricant and the average particle size of the fine powder.

In one aspect, the invention provides a rare earth sintered magnet comprising R, Fe, and B wherein R is at least one element selected from rare earth elements, essentially including Nd, the magnet having a carbon concentration of 800 to 1,400 ppm, an oxygen concentration of up to 1,000 ppm, and a nitrogen concentration of up to 800 ppm, an average crystal grain size D50 (μm) of up to 4.5 μm, which is defined as an area average of the diameters of circles equivalent to crystal grains in a plane parallel to the magnetization direction, and a degree of orientation Or (%) which is defined by the formula (1) as a function of a remanence Br and a saturated magnetic flux density 4πIs,

Or=(Br/4πIs)*100 (1)

wherein D50 and Or meet the relationship of formula (2):

Or>0.7*D50+95 (7)

The sintered magnet may further comprise 0.05 to 0.5 atom % of X which is at least one element selected from Ti, Zr, Hf, Nb, V, and Ta. The relationship of formula (3):

4.3<[B]−2[X]<5.5 (3)

is fulfilled wherein [B] is atom % of B and [X] is atom % of X.

In a preferred embodiment, the content of R is 12.5 to 15.0 atom %.

In a preferred embodiment, R contains more than 0% to 1% by weight of at least one element selected from Dy, Tb, Gd, and Ho.

Element R which is introduced into the magnet after sintering by grain boundary diffusion may be included as part of R.

In another aspect, the invention provides a method for preparing a rare earth sintered magnet, comprising the steps of finely pulverizing a coarse alloy powder into a fine powder, the alloy containing R, Fe, and B, shaping the fine powder under a magnetic field into a compact, and heat treating the compact into a sintered body. The finely pulverizing step includes adding a compound having a polar functional group and a cyclohexane skeleton to the coarse alloy powder to provide a source powder, and finely pulverizing the source powder in an inert gas atmosphere to an average particle size of 0.5 to 3.5 μm, which is a median diameter in a volume basis particle size distribution as measured by the laser diffraction/scattering method.

Preferably the compound having a polar functional group and a cyclohexane skeleton has a molecular weight of up to 250. Also preferably, the compound has a vapor pressure of up to 15 Pa at 25° C. Typically, the polar functional group is OH, COOH, CH₃COO or NH₂. Further preferably, the compound is added in an amount of 0.08 to 0.3 parts by weight per 100 parts by weight of the coarse alloy powder.

In a preferred embodiment, the rare earth sintered magnet prepared by the method has an oxygen concentration of up to 1,000 ppm and/or a nitrogen concentration of up to 800 ppm.

Preferably, the compact has a density of 2.8 to 3.6 g/cm³.

Also preferably, the compact has a strength of at least 20 N as measured by forcing a push-pull gauge to the compact and reading the force of the gauge at which the compact is cracked.

### Advantageous Effect of Invention

According to the invention, there is obtained a rare earth sintered magnet of excellent magnetic performance having high values of both Br and H_{cJ}.

### BRIEF DESCRIPTION OF DRAWINGS

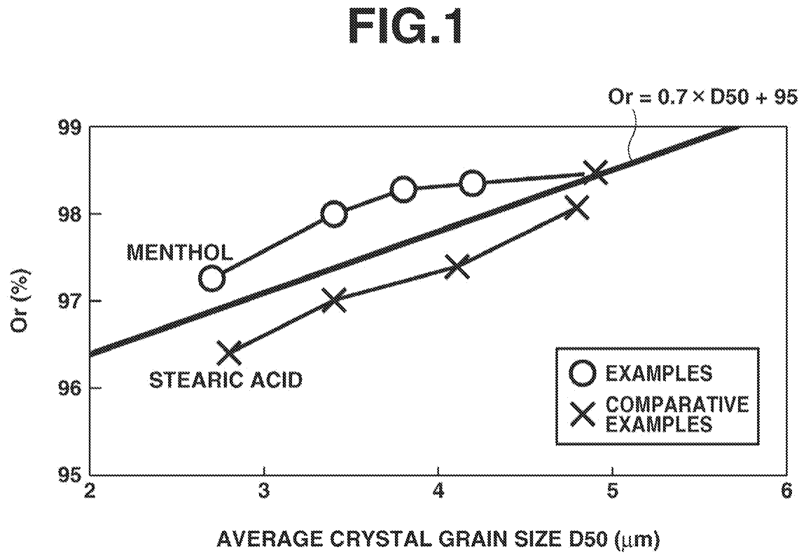

The only FIGURE, FIG. 1 is a diagram showing the relationship of average crystal grain size D50 to degree of orientation Or of the rare earth sintered magnets of Examples 1, 8 to 10 using menthol as the lubricant and Comparative Examples 1, 8 to 11 using stearic acid as the lubricant.

### DESCRIPTION OF PREFERRED EMBODIMENTS

The invention provides a rare earth sintered magnet comprising R, Fe, and B, having a carbon concentration of 800 to 1,400 ppm, an oxygen concentration of up to 1,000 ppm, and a nitrogen concentration of up to 800 ppm, and meeting a specific relationship of an average crystal grain size D50 (μm) to a degree of orientation Or (%).

R constituting a rare earth sintered magnet of the invention is at least one element selected from rare earth elements, specifically Nd, Pr, La, Ce, Gd, Dy, Tb, and Ho, preferably Pr, Nd, Dy, and Tb, R essentially includes Nd. It is permissible that element R which is introduced into the sintered magnet by grain boundary diffusion is included as part of element R.

The content of R is preferably at least 12.5 atom %, more preferably at least 12.7 atom % from the standpoints of preventing α-Fe from crystallizing in the source alloy during preparation and achieving densification to a full extent. Although it is difficult to eliminate α-Fe even when homogenization is conducted, the R content in the range is effective for suppressing a substantial drop of H_{cJ} and squareness of a R—Fe—B sintered magnet. This also holds true when the source alloy is prepared by the strip casting method which minimizes a likelihood of crystallization of α-Fe. In addition, the R content in the range avoids that the amount of a liquid phase composed mainly of R component having the role of promoting densification in the sintering step (to be described later) is reduced to detract from sinterability so that a R—Fe—B sintered magnet is insufficiently densified. On the other hand, if the R content exceeds 14 atom %, the proportion of R₂Fe₁₄B phase in the sintered magnet is reduced with a concomitant drop of Br. For this reason, the R content is preferably up to 15.0 atom %, more preferably up to 14.0 atom %.

It is also preferred that R contain at least one element selected from Dy, Tb, Gd, and Ho in an amount of more than 0% by weight to 1% by weight, more preferably more than 0.3% by weight to 0.8% by weight. Since Dy, Tb, Gd, and Ho are effective for enhancing H_{cJ} even in small amounts of addition, it is recommended to add Dy, Tb, Gd, and/or Ho to a magnet. For the reason that Dy, Tb, Gd, and Ho are more rare and expensive than Nd, and from the aspect of suppressing a drop of Br by their addition, the amount of Dy, Tb, Gd, and/or Ho added is preferably up to 1% by weight.

As mentioned above, the magnet contains Fe and B as essential elements. The contents of Fe and B are not particularly limited. The content of Fe is preferably at least 75 atom %, more preferably at least 77 atom %, and preferably up to 83 atom %, more preferably up to 81 atom %. The content of B is preferably 5.0 to 6.0 atom %, more preferably 5.3 to 5.7 atom %.

Preferably the rare earth sintered magnet further contains X which is at least one element selected from Ti, Zr, Hf, Nb, V, and Ta. The content of X is preferably at least 0.05 atom %, more preferably at least 0.1 atom % from the aspect of fully exerting the effect of suppressing abnormal grain growth in the sintering step. The content of X is preferably up to 0.5 atom %, more preferably up to 0.3 atom % for reducing or eliminating the risk that the formation of X—B phase reduces the amount of B necessary to form R₂Fe₁₄B phase, a concomitant reduction of the proportion of R₂Fe₁₄B phase invites a drop of Br, and formation of R₂Fe₁₇ phase invites a substantial drop of H_{cJ}. Further, X forms XB₂ phase with B, indicating that B as one constituent of the main phase is consumed. It is necessary to afford a sufficient amount of the main phase to provide a high Br. With respect to carbon (C) which originates from a lubricant which is added much in order to achieve high orientation and is capable of partially replacing B in the main phase, to permit a relatively high carbon concentration, the contents of B and X preferably meet the relationship of formula (3), more preferably the relationship of formula (3′):

4.3<[B]−2[X]<5.5 (3)

4.5<[B]−2[X]<5.3 (3′)

wherein [B] is atom % of B and [X] is atom % of X.

The sintered magnet should have a carbon concentration of 800 to 1,400 ppm as mentioned above, preferably 900 to 1,200 ppm. With a carbon concentration in excess of 1,400 ppm, H_{cJ} declines. With a carbon concentration of less than 800 ppm, no sufficient orientation is achieved.

The sintered magnet should have an oxygen concentration of up to 1,000 ppm as mentioned above, preferably up to 800 ppm, from the aspect of acquiring high Br by reducing impurities and reducing the amount of R added. As will be described later in connection with the preparation method, the oxygen concentration of a sintered body is strongly affected by the presence of oxygen and moisture in the fine pulverization step of the source powder. If the oxygen concentration exceeds 1,000 ppm, outstanding oxidation and hydroxylation occur on the surface of fine particles, and adsorptive sites on the metal surface become so few that the amount of lubricant adsorbed is reduced, failing to exert its effect to a full extent.

The sintered magnet should have a nitrogen concentration of up to 800 ppm as mentioned above, preferably up to 500 ppm, more preferably up to 400 ppm from the aspect of acquiring satisfactory H_{cJ}.

The sintered magnet should meet a specific relationship of an average crystal grain size D50 (μm) to a degree of orientation Or (%) as mentioned above. The average crystal grain size is defined as a median value D50 (μm) of the diameters of circles equivalent to the area of crystal grains in a plane parallel to the magnetization direction. The average crystal grain size D50 is up to 4.5 μm, preferably up to 4.0 μm, more preferably up to 3.5 μm. If the grain size D50 exceeds 4.5 μm, no satisfactory H_{cJ} is obtained. Although the lower limit of the grain size D50 is not critical, the grain size D50 is preferably at least 1.2 μm, more preferably at least 1.8 μm from the aspect of acquiring a satisfactory degree of orientation from an appropriate range of the lubricant added.

The average crystal grain size D50 is measured, for example, by the following procedure. A cross section of a sintered magnet parallel to its magnetization direction is polished to mirror finish. The magnet is immersed in an etchant, for example, Vilella reagent (mixture of glycerol, nitric acid and hydrochloric acid in a ratio of 3:1:2) to selectively etch the grain boundary phase. The etched cross section is observed under a laser microscope to take a cross-sectional image, on which an image analysis is made. The cross-sectional area of individual grains is measured, from which the diameter of equivalent circle is computed. An average crystal grain size is preferably an average of the diameters of multiple grains in images of plural spots. The average grain size is, for example, an area basis median diameter of total approximately 2,000 or more grains in images of different 20 spots.

The degree of orientation Or (%) is defined by the formula (1) as a function of a remanence Br and a saturated magnetic flux density 4πIs.

Or=(Br/4πIs)*100 (1)

The remanence Br is determined by measuring the magnetic properties of a sintered magnet by a BH tracer.

As mentioned above, the sintered magnet has an average crystal grain size D50 (μm) and a degree of orientation Or (%), defined as above, which meet the relationship of the formula (2).

Or>0.7*D50+95 (2)

Then the sintered magnet exhibits both the H_{cJ} enhancing effect associated with miniaturization of crystal grain size and high values of Br.

Another embodiment of the invention is a method for preparing a rare earth sintered magnet. The method for preparing the rare earth sintered magnet defined above involves the steps of finely pulverizing a coarsely ground alloy powder into a fine powder, the alloy containing R, Fe, and B, shaping the fine powder under a magnetic field into a compact, and heat treating the compact into a sintered body.

The inventive method for preparing a rare earth sintered magnet involves steps which are basically the same as the steps in the standard powder metallurgy. Though not particularly limited, the inventive method typically involves the step of melting raw ingredients to form a raw alloy having a predetermined composition, and the step of pulverizing the raw alloy into an alloy powder. The pulverizing step includes a coarse pulverizing step of obtaining a coarsely divided powder and a fine pulverizing step of obtaining a finely divided powder.

First, in the melting step, metals or alloys as raw materials for necessary elements are weighed so as to give the predetermined composition. After weighing, the raw materials are melted by heating, for example, high-frequency induction heating. The melt is cooled to form a starting alloy having the predetermined composition. For casting of the starting alloy, the melt casting technique of casting in a flat mold or book mold or the strip casting technique is generally employed. Also applicable herein is a so-called two-alloy technique involving separately furnishing an alloy approximate to the R₂Fe₁₄B compound composition that is the main phase of R—Fe—B alloy and an R-rich alloy serving as liquid phase aid at the sintering temperature, crushing, then weighing and mixing them. Since the alloy approximate to the main phase composition tends to allow α-Fe phase to crystallize depending on the cooling rate during casting and the alloy composition, the alloy is preferably subjected to homogenizing treatment in vacuum or Ar atmosphere at 700 to 1,200° C. for at least 1 hour, if desired, for the purpose of homogenizing the structure to eliminate the α-Fe phase. When the alloy approximate to the main phase composition is prepared by the strip casting technique, the homogenizing treatment may be omitted. To the R-rich alloy serving as liquid phase aid, not only the casting technique mentioned above, but also the so-called melt quenching technique are applicable.

The pulverizing step is a multi-stage step including at least coarse pulverizing and fine pulverizing steps. In the coarse pulverizing step, any suitable technique such as grinding on a jaw crusher, Brown mill or pin mill, or hydrogen decrepitation may be used. To the alloy which is prepared by the strip casting technique, the hydrogen decrepitation step is typically applied, obtaining a coarse powder which has been coarsely pulverized to a size of 0.05 to 3 mm, especially 0.05 to 1.5 mm.

The coarse pulverizing step is followed by the fine pulverizing step where a lubricant is added to the coarse powder, which is pulverized on a jet mill, for example.

In the fine pulverizing step of the inventive method, a compound having a polar functional group and a cyclohexane skeleton is used as the lubricant. The coarse powder having the lubricant added thereto is pulverized into a fine powder preferably having an average particle size of 0.5 to 3.5 μm. The average particle size of the fine powder is more preferably 1.0 to 3.0 μm, even more preferably 1.5 to 2.8 μm. By using the specific compound as the lubricant, pulverizing the coarse powder into a fine powder having an average particle size in the specific range, shaping the fine powder into a compact, and heat treating the compact into a sintered body, a rare earth sintered magnet having the desired magnetic properties is obtained. It is noted that the average particle size of powder is a median diameter in the volume basis particle size distribution as analyzed by the laser diffraction/scattering method.

Although it is not well understood why the desired magnetic properties are obtained, the reason is presumed as follows. In the prior art, straight fatty acids, specifically fatty acids having a long straight alkyl group are commonly used as the lubricant, which are referred to as “conventional lubricant,” hereinafter. According to the invention, the compound having a polar functional group and a cyclohexane skeleton is used as the lubricant. Owing to the polar functional group, the compound effectively adsorbs to fine particles. The cyclohexane skeleton due to its steric molecular structure augments the repulsion between fine particles and exerts the effect of helping fine particles disperse, as compared with the conventional lubricant. When the compound having a polar functional group and a cyclohexane skeleton is used as the lubricant, the frictional force between fine particles increases as compared with the conventional lubricant. Particularly when a fine powder has an average particle size larger than a certain value or a wide particle size distribution, the shaping cavity is effectively or densely filled with the fine powder in the shaping step of the magnet preparation method so that more contacts occur among fine particles. The influence of frictional forces between particles becomes strong during orientation in a magnetic field, and as a result, the degree of orientation is aggravated as compared with the conventional lubricant. On the other hand, when a fine powder has an average particle size smaller than a certain value or a narrow particle size distribution, the shaping cavity is ineffectively or sparsely filled with the fine powder in the shaping step so that fewer contacts occur among fine particles. Since the compound of sterically large molecular structure exerts the effect of improving the dispersibility of fine powder, which surpasses the influence of increased frictional forces between particles, the orientation during shaping in a magnetic field is improved.

The lubricant compound has a polar functional group for the purpose of promoting chemical adsorption of the lubricant to surfaces of particles. Preferred examples of the polar functional group include OH, NH₂, COOH, and CH₃COO groups because these groups are regarded effective for adsorption to fine particles and can be independently kept at the molecular end.

Examples of the lubricant are given below, but not limited thereto. Suitable compounds having a polar functional group and a cyclohexane skeleton include cyclohexanol, cyclohexylamine, cyclohexanone, cyclohexylcarboxylic acid, 1,4-cyclohexanedicarboxylic acid, and methyl cyclohexanecarboxylate as well as cyclic terpene derivatives having a cyclohexane skeleton within the molecule, such as menthol, menthone, camphor, camphorquinone, borneol, isoborneol, isobornyl acetate, and norbornanone. When optical isomers exist for a certain compound, its effect is not restricted by the steric structure. A plurality of compounds may be used in combination as long as their total amount of addition is within the predetermined range.

The lubricant should preferably have a molecular weight of up to 250, more preferably up to 200 as viewed from the number of molecules which are necessary to cover fine particles fully when the lubricant is added in a predetermined amount.

In the fine pulverization step, the lubricant is added to the coarse powder in the jet mill system. While a large amount of the coarse powder is continuously pulverized, the lubricant concentration within the jet mill will ramp, with a risk that the lubricant precipitates in a low-temperature section of the jet mill. There is also a risk that the sintered magnet has an excessively increased carbon concentration. For the purpose of minimizing these risks, the lubricant should preferably have a vapor pressure at 25° C. of up to 15 Pa, more preferably up to 10 Pa. Although the state of the lubricant at room temperature is not particularly limited, the lubricant is preferably liquid at 25° C. as viewed from more uniform coverage of fine particles with the lubricant in the fine pulverization step.

The lubricant is added in an amount of at least 0.08 part by weight, more preferably at least 0.10 part by weight per 100 parts by weight of the coarse powder, from the aspect of achieving a satisfactory degree of orientation for fine particles which are as small as a particle size of up to 3.5 μm and difficult to orient or align. The lubricant is added in an amount of up to 0.3 part by weight, more preferably up to 0.2 part by weight per 100 parts by weight of the coarse powder, from the aspect of preventing H_{cJ} from lowering by an increase of carbon.

At the end of the fine pulverization step, the fine powder should have a particle size of 0.5 to 3.5 μm, preferably 1.0 to 3.0 μm, more preferably 1.5 to 2.8 μm as mentioned above. The lower limit of 0.5 μm is set from the aspect of preventing oxidation and nitriding of fine particles and the aspect of obtaining satisfactory H_{cJ}. The upper limit of 3.5 μm is set from the aspect of obtaining satisfactory H_{cJ}.

The fine powder thus obtained is compression shaped in a magnetic field applied thereto to form a compact. The compact is then heat treated into a sintered body, that is, sintered magnet.

In the shaping step, the alloy powder is compression shaped into a compact by a compression shaping machine while applying a magnetic field of 400 to 1,600 kA/m for orienting or aligning alloy particles in the direction of axis of easy magnetization. The compact preferably has a density of 2.8 to 3.6 g/cm³, more preferably 3.0 to 3.4 g/cm³. It is preferred from the aspect of establishing a compact strength for easy handling that the compact have a density of at least 2.8 g/cm³. It is also preferred from the aspects of establishing a sufficient compact strength and achieving sufficient particle orientation during compression to gain appropriate Br that the compact have a density of up to 3.6 g/cm³. This range of density enables to suppress a drop of Br as a result of disordering of orientation of particles which are aligned in the direction of a magnetic field applied during compression, when the compact has a high strength. The shaping step is preferably performed in an inert gas atmosphere such as nitrogen gas or Ar gas to prevent the alloy powder from oxidation.

The compact shaped from the fine powder having the specific lubricant compound added thereto has a high strength, as compared with the compact similarly shaped using the conventional lubricant (typically stearic acid), owing to the increased frictional forces between fine particles as discussed above. This reduces chances of cracking or chipping of the compact, from which an improvement in productivity is expected. Also, the compact can be shaped under a lower compression pressure than in the prior art while maintaining a sufficient strength. Any disordering of orientation during compression shaping is suppressed, and higher values of Br are obtained.

The strength of a compact is measured by such a test as a compression test or flexural strength test using a load cell. Since the compact can ignite in air, it is preferably tested by a simple evaluation method including the steps of placing the compact of predetermined shape in a globe box, forcing a push-pull gauge to the compact from above, and measuring the rupture pressure at the instant when the compact is cracked. The strength of a compact may be measured, for example, by a digital force gauge RZ-10 with motorized stand Model-2257 (by Aikoh Engineering Co., Ltd.). The compact preferably has a strength of at least 20 N, more preferably at least 30 N as measured by this gauge, from the standpoint of minimizing the aggravation of manufacture yield by rupture of the compact by spring-back upon removal of the compact from the die after compression shaping, collapse of the compact by clamping of the compact or securing of the compact by a vacuum chuck pad, and breakage or chipping at edges of the compact upon placement of the compact in the heat treating vessel.

In the heat treatment step, the compact resulting from the shaping step is sintered in high vacuum or a non-oxidative atmosphere such as Ar gas. Typically, the compact is sintered by holding the compact at a temperature in the range of 950° C. to 1,200° C. for 0.5 to 10 hours. After the sintering, the sintered body is cooled by any of cooling modes including gas quenching at a cooling rate of at least 20° C./min, controlled cooling at a cooling rate of 1 to 20° C./min, and furnace cooling. The R—Fe—B sintered magnet has equivalent magnetic properties independent of the cooling mode.

After the heat treatment for sintering, the sintered body may be further heat treated at a temperature lower than the sintering temperature for the purpose of enhancing H_{cJ} although this post heat treatment is not essential. The heat treatment after the sintering step may be heat treatment in two stages including high-temperature heat treatment and low-temperature heat treatment, or only low-temperature heat treatment. The high-temperature heat treatment is preferably to heat treat the sintered body at 600 to 950° C. The low-temperature heat treatment is preferably to heat treat the sintered body at 400 to 600° C. After the post heat treatment, the sintered body is cooled by any of cooling modes including gas quenching at a cooling rate of at least 20° C./min, controlled cooling at a cooling rate of 1 to 20° C./min, and furnace cooling. The R—Fe—B sintered magnet has equivalent magnetic properties independent of the cooling mode.

The sintered body obtained from the heat treatment is measured for magnetic properties by a BEE tracer, one of the magnetic properties being a degree of orientation. When the sintered body has a small average crystal grain size, it corresponds to a small particle size, which indicates a reduced likelihood of orientation in a magnetic field during shaping step, leading to a lower degree of orientation. Nevertheless, when the degree of orientation Or (%) and the average crystal grain size D50 (μm) meet the relationship of formula (2): Or>0.7*D50+95, the magnet exhibits both the enhancing effect due to miniaturization of crystal grain size and a high Br. From the aspect of obtaining the desired effect from miniaturization of crystal grain size, the average crystal grain size D50 (μm) is up to 4.5 μm, preferably up to 4.0 μm, more preferably up to 3.5 μm.

The carbon concentration of the sintered magnet obtained from the heat treatment is dependent on the amount of the lubricant added in the fine pulverization step. When a large amount of the lubricant is added with the aim of obtaining high Br, the carbon concentration becomes high, leading to a lowering of H_{cJ}. When the amount of the lubricant added is small, no sufficient orientation is achieved. For this reason, the carbon concentration of the sintered magnet is in the range of 800 to 1,400 ppm, preferably 900 to 1,200 ppm.

The oxygen concentration of the sintered magnet obtained from the heat treatment is up to 1,000 ppm, preferably up to 800 ppm, from the aspect of obtaining high Br by reducing the amount of R added while reducing impurities. Also, the oxygen concentration of the sintered body is largely affected by the presence of oxygen and moisture in the fine pulverization step. If the oxygen concentration exceeds 1,000 ppm, no sufficient effects are exerted because oxidation and hydroxylation at fine particle surfaces become outstanding, adsorptive sites on metal surface are reduced, and the amount of the lubricant adsorbed is reduced.

The nitrogen concentration of the sintered magnet obtained from the heat treatment is up to 800 ppm, preferably up to 500 ppm, more preferably up to 400 ppm, from the aspect of obtaining satisfactory H_{cJ}. When nitrogen is used as the inert gas in the fine pulverization step or shaping step, the concentration of oxygen and moisture in the inert gas is reduced, empty adsorptive sites on fine particle surfaces become more, and more nitrogen is adsorbed. As a result, the nitrogen concentration of the sintered magnet rises. Since a rise of the nitrogen concentration of the sintered magnet invites a lowering of H_{cJ}, the nitrogen concentration is desirably low. As to the fine powder having an average particle size of up to 3.5 μm, the following is confirmed. Although the amount of nitrogen adsorbed increases as a result of a sharp increase of specific surface area associated with a reduction of particle size of the fine powder, the nitrogen concentration can be reduced as compared with the conventional lubricant by performing fine pulverization after the addition of a compound having a polar functional group and a cyclohexane skeleton.

The sintered magnet may be subjected to grain boundary diffusion treatment using Dy or Tb. As long as the nitrogen concentration is reduced to 800 ppm or below, stable magnetic properties are obtained without losing the increased H_{cJ} after the grain boundary diffusion.

### EXAMPLES

Examples of the invention are given below by way of illustration and not by way of limitation.

### Examples 1 to 7 and Comparative Examples 1 to 4

A ribbon form alloy was prepared by the strip casting technique, specifically by using a high-frequency induction furnace, melting metal ingredients in Ar gas atmosphere therein so as to meet the desired composition: Nd 30.0 wt %, Co 1.0 wt %, B 0.9 wt %, Al 0.1 wt %, Cu 0.2 wt %, Zr 0.2 wt %, Ga 0.1 wt %, and Fe balance, and casting the melt on a water-cooled supper chill roll. The ribbon form alloy was coarsely pulverized by hydrogen decrepitation. To the coarse powder, 0.15% by weight of a lubricant was added and mixed, specifically menthol (Example 1), cyclohexanecarboxylic acid (Example 2), cyclohexanol (Example 3), camphor (Example 4), borneol (Example 5), camphorquinone (Example 6), isobornyl acetate (Example 7), steric acid (Comparative Example 1), cyclohexane (Comparative Example 2), adamantane (Comparative Example 3), and camphene (Comparative Example 4). Using a jet mill, the coarse powder/lubricant mixture was finely pulverized in a nitrogen stream having controlled oxygen and moisture concentrations into a fine powder having an average particle size of 2.8 μm.

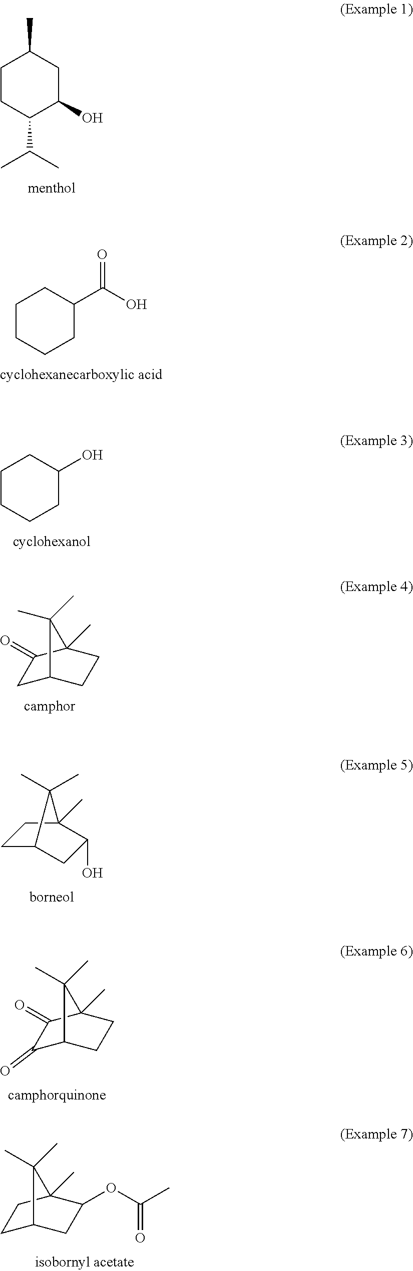

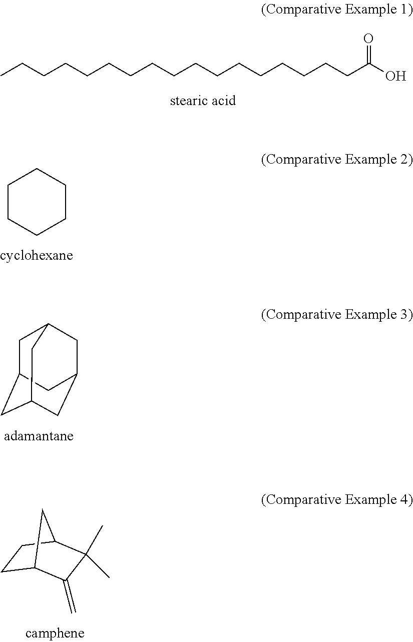

A mold of a shaping machine equipped with an electromagnet was filled with the fine powder in nitrogen atmosphere. While being oriented under a magnetic field of 15 kOe (1.19 MA/m), the powder was compression shaped under a load of 10 kN in a direction perpendicular to the magnetic field. The resulting compact was sintered in vacuum at 1,050° C. for 3 hours, cooled below 200° C., and subjected to high-temperature heat treatment at 900° C. for 2 hours and low-temperature heat treatment at 500° C. for 3 hours, yielding a sintered body.

A parallelopiped block (sintered magnet) of 18 mm by 15 mm by 12 mm was cut out from a central portion of the sintered body. Magnetic properties of the sintered magnet were measured by a B—H tracer. Table 1 tabulates the measured properties of Examples 1 to 7 and Comparative Examples 1 to 4. It is noted that for the sintered magnet, the oxygen concentration was measured by the inert gas fusion-infrared absorption spectrometry, the nitrogen concentration measured by the inert gas fusion-thermal conductivity method, and the carbon concentration measured by the infrared absorptiometry after combustion. The average crystal grain size D50 (μm) was measured by polishing a cross section of the sintered magnet parallel to its magnetization direction until mirror finish, immersing the magnet in an etchant which was a 3:1:2 mixture of glycerin, nitric acid and hydrochloric acid to selectively etch the grain boundary phase, observing the etched cross section wider a laser microscope to take 25 cross-sectional images of 85×85 μm area, making an image analysis on the images to determine the cross-sectional area of individual grains, computing the diameter of equivalent circles, and computing an area average of grain diameters.

### Comparative Example 5

A ribbon form alloy was prepared by the strip casting technique, specifically by using a high-frequency induction furnace, melting metal ingredients in Ar gas atmosphere therein so as to meet the desired composition: Nd 30.0 wt %, Co 1.0 wt %, B 0.9 wt %, Al 0.1 wt %, Cu 0.2 wt %, Zr 0.2 wt %, Ga 0.1 wt %, and Fe balance, and casting the melt on a water-cooled copper chill roll. The ribbon form alloy was coarsely pulverized by hydrogen decrepitation. To the coarse powder, 0.15% by weight of menthol as lubricant was added, Using a jet mill, the coarse powder/lubricant mixture was finely pulverized in a nitrogen stream having controlled oxygen and moisture concentrations into a fine powder having an average particle size of 2.8 μm. At this point in time, the oxygen concentration in the jet mill system was adjusted such that the fine powder might have an oxygen content of 1,500 ppm.

A mold of a shaping machine equipped with an electromagnet was filled with the fine powder in nitrogen atmosphere. While being oriented under a magnetic field of 15 kOe (1.19 MA/m), the powder was compression shaped under a load of 10 kN in a direction perpendicular to the magnetic field. The resulting compact was sintered in vacuum at 1,050° C. for 3 hours, cooled below 200° C., heat treated at a high temperature of 900° C. for 2 hours and heat treated at a low temperature of 500° C. for 3 hours, yielding a sintered body. As in Example 1, the sintered magnet was analyzed for magnetic properties, impurity element contents, and average crystal grain size. The results are also shown in Table 1.

### Comparative Examples 6 and 7

A ribbon form alloy was prepared by the strip casting technique, specifically by using a high-frequency induction furnace, melting metal ingredients in Ar gas atmosphere therein so as to meet the desired composition: Nd 30.0 wt %, Co 1.0 wt %, B 0.9 wt %, Al 0.1 wt %, Cu 0.2 wt %, Zr 0.2 wt %, Ga 0.1 wt %, and Fe balance, and casting the melt on a water-cooled copper chill roll. The ribbon form alloy was coarsely pulverized by hydrogen decrepitation. To the coarse powder, a lubricant was added and mixed, specifically 0.07% by weight (Comparative Example 6) and 0.32% by weight (Comparative Example 7) of menthol. Using a jet mill, the coarse powder/lubricant mixture was finely pulverized in a nitrogen stream having controlled oxygen and moisture concentrations into a fine powder having an average particle size of 2.8 μm.

A mold of a shaping machine equipped with an electromagnet was filled with the fine powder in nitrogen atmosphere. While being oriented under a magnetic field of 15 kOe (1.19 MA/m), the powder was compression shaped under a load of 10 kN in a direction perpendicular to the magnetic field. The resulting compact was sintered in vacuum at 1,050° C. for 3 hours, cooled below 200° C., heat treated at a high temperature of 900° C. for 2 hours and heat treated at a low temperature of 500° C. for 3 hours, yielding a sintered body. As in Example 1, the sintered magnet was analyzed for magnetic properties, impurity element contents, and average crystal grain size. The results are also shown in Table 1.

TABLE 1

| | | | Lubricant | | | | | | | | |
|---|---|---|---|---|---|---|---|---|---|---|---|
| | | | amount | D50 | Br | H_{cJ} | | Or | C | O | N |
| | | Lubricant | (wt %) | (μm) | (T) | (kA/m) | 0.7*D50 + 95 | (%) | (ppm) | (ppm) | (ppm) |
| Example | 1 | menthol | 0.15 | 3.4 | 1.470 | 1,042 | 97.4 | 98.0 | 1,190 | 550 | 380 |
| | 2 | cyclohexanecarboxylic | 0.15 | 3.4 | 1.470 | 1,051 | 97.4 | 98.0 | 1,050 | 630 | 360 |
| | | acid | | | | | | | | | |
| | 3 | cyclohexanol | 0.15 | 3.4 | 1.471 | 1,045 | 97.4 | 98.1 | 1,110 | 600 | 370 |
| | 4 | camphor | 0.15 | 3.4 | 1.475 | 1,022 | 97.4 | 98.3 | 1,160 | 610 | 350 |
| | 5 | borneol | 0.15 | 3.4 | 1.470 | 1,043 | 97.4 | 98.0 | 1,150 | 580 | 360 |
| | 6 | camphorquinone | 0.15 | 3.4 | 1.466 | 1,039 | 97.4 | 97.7 | 1,130 | 620 | 390 |
| | 7 | isobornyl acetate | 0.15 | 3.4 | 1.469 | 1,048 | 97.4 | 97.9 | 1,180 | 490 | 370 |
| Comparative | 1 | stearic acid | 0.15 | 3.4 | 1.455 | 1,027 | 97.4 | 97.0 | 1,180 | 590 | 610 |
| Example | 2 | cyclohexane | 0.15 | 3.4 | 1.435 | 1,113 | 97.4 | 95.7 | 1,070 | 720 | 910 |
| | 3 | adamantane | 0.15 | 3.4 | 1.439 | 1,076 | 97.4 | 95.9 | 1,100 | 660 | 980 |
| | 4 | camphene | 0.15 | 3.4 | 1.433 | 1,081 | 97.4 | 95.5 | 1,070 | 650 | 970 |
| | 5 | menthol | 0.15 | 3.5 | 1.448 | 682 | 97.5 | 96.5 | 1,100 | 1,480 | 80 |
| | 6 | menthol | 0.07 | 3.4 | 1.451 | 909 | 97.4 | 96.7 | 690 | 710 | 850 |
| | 7 | menthol | 0.32 | 3.3 | 1.479 | 877 | 97.3 | 98.6 | 1,470 | 800 | 220 |

It is evident from Table 1 that the sintered magnets of Examples 1 to 7 which were prepared by the method fulfilling the requirements of the invention show both high values of Br and H_{cJ} due to a satisfactory degree of orientation relative to crystal grain size and a low nitrogen concentration, as compared with Comparative Examples 1 to 7. The magnet of Comparative Example 5 shows a lowering of Br due to insufficient densification from a shortage of sintering caused by a high oxygen concentration of 1,480 ppm. The magnet of Comparative Example 6 using a smaller amount of the lubricant and hence, having a lower carbon concentration shows a lowering of Br due to an insufficient degree of orientation. The magnet of Comparative Example 7 using an outstandingly large amount of the lubricant shows a lowering of H_{cJ} due to a high carbon concentration.

### Examples 8 to 10 and Comparative Examples 8 to 11

A ribbon form alloy was prepared by the strip casting technique, specifically by using a high-frequency induction furnace, melting metal ingredients in Ar gas atmosphere therein so as to meet the desired composition: Nd 30.0 wt %, Co 1.0 wt %, B 0.9 wt %, Al 0.1 wt %, Cu 0.2 wt %, Zr 0.2 wt %, Ga 0.1 wt %, and Fe balance, and casting the melt on a water-cooled cupper chill roll. The ribbon form alloy was coarsely pulverized by hydrogen decrepitation. To the coarse powder, 0.15% by weight of menthol as lubricant was added. Using a jet mill, the coarse powder/lubricant mixture was finely pulverized in a nitrogen stream, By changing the rotational speed of the classifier, fine pulverization was performed so as to reach an average particle size of 2.1 μm (Example 8), 3.1 μm (Example 9), 3.5 μm (Example 10) or 4.0 μm (Comparative Example 8). Similarly, 0.15% by weight of stearic acid as lubricant was added to and mixed with the coarse powder. The mixture was finely pulverized in a nitrogen stream having controlled oxygen and moisture concentrations. By changing the rotational speed of the classifier of the jet mill, fine pulverization was performed so as to reach an average particle size of 2.1 μm (Comparative Example 9), 3.5 μm (Comparative Example 10) or 4.0 μm (Comparative Example 11).

A mold of a shaping machine equipped with an electromagnet was filled with the fine powder in nitrogen atmosphere. While being oriented under a magnetic field of 15 kOe (1.19 MA/m), the powder was compression shaped under a load of 10 kN in a direction perpendicular to the magnetic field. The resulting compact was sintered in vacuum at 1,050° C. for 3 hours, cooled below 200° C. heat treated at a high temperature of 900° C. for 2 hours and heat treated at a low temperature of 500° C. for 3 hours, yielding a sintered body. As in Example 1, the sintered magnet was analyzed for magnetic properties, impurity element contents, and average crystal grain size. The results are shown in Table 2.

TABLE 2

| | | | Lubricant | | | | | | | | |
|---|---|---|---|---|---|---|---|---|---|---|---|
| | | | amount | D50 | Br | H_{cJ} | | Or | C | O | N |
| | | Lubricant | (wt %) | (μm) | (T) | (kA/m) | 0.7*D50 + 95 | (%) | (ppm) | (ppm) | (ppm) |
| Example | 8 | menthol | 0.15 | 2.7 | 1.459 | 1,103 | 96.9 | 97.3 | 1,240 | 640 | 740 |
| | 9 | menthol | 0.15 | 3.8 | 1.474 | 1,022 | 97.7 | 98.3 | 1,150 | 490 | 230 |
| | 10 | menthol | 0.15 | 4.2 | 1.475 | 984 | 97.9 | 98.3 | 1,100 | 570 | 130 |
| Comparative | 8 | menthol | 0.15 | 4.9 | 1.477 | 896 | 98.4 | 98.5 | 1,030 | 430 | 160 |
| Example | 9 | stearic acid | 0.15 | 2.8 | 1.446 | 1,051 | 97.0 | 96.4 | 1,150 | 660 | 900 |
| | 10 | stearic acid | 0.15 | 4.1 | 1.461 | 947 | 97.9 | 97.4 | 1,180 | 770 | 210 |
| | 11 | stearic acid | 0.15 | 4.8 | 1.471 | 894 | 98.4 | 98.1 | 1,120 | 530 | 100 |

The results of Example 1 and Comparative Example 1 in Table 1 are combined with the results in Table 2 to compare the sintered magnets which are prepared using menthol (which is a compound having a polar functional group and a cyclohexane skeleton within the scope of the invention) and stearic acid (which is a straight saturated fatty acid) as the lubricant. FIG. 1 graphically depicts the relationship of average crystal grain size D50 to degree of orientation Or of these magnets.

As seen from FIG. 1, the magnets prepared using menthol which is a compound having a polar functional group and a cyclohexane skeleton and having an average crystal grain size DSO of up to 4.5 μm have a high degree of orientation Or, as compared with the magnets prepared using stearic acid or the conventional lubricant. Of the magnets having an average crystal grain size D50 in excess of 4.5 μm, the magnet prepared using menthol as the lubricant (Comparative Example 8) shows the highest value of Br, but a lower value of H_{cJ} than Examples. As evident from these results, the magnets show both a high degree of orientation Or and high H_{cJ} when the average crystal grain size DSO of up to 4.5 μm and the relationship: Or>0.7*D50+95 are fulfilled.

### Examples 11 to 13 and Comparative Examples 12 to 14

A ribbon form alloy was prepared by the strip casting technique, specifically by using a high-frequency induction furnace, melting metal ingredients in Ar gas atmosphere therein so as to meet the desired composition: Nd 30.0 wt %, Co 1.0 wt %, B 0.9 wt %, Al 0.1 wt %, Cu 0.2 wt %, Zr 0.2 wt %, Ga 0.1 wt %, and Fe balance, and casting the melt on a water-cooled cupper chill roll. The ribbon form alloy was coarsely pulverized by hydrogen decrepitation. To the coarse powder, 0.15% by weight of menthol as lubricant was added. Using a jet mill, the coarse powder/lubricant mixture was finely pulverized in a nitrogen stream having controlled oxygen and moisture concentrations into a fine powder having an average particle size of 2.9 μm (Examples 11 to 13). Similarly, 0.15% by weight of lauric acid as lubricant was added to and mixed with the coarse powder. Using a jet mill, the coarse powder/lubricant mixture was finely pulverized in a nitrogen stream having controlled oxygen and moisture concentrations into a fine powder having an average particle size of 2.9 μm (Comparative Examples 12 to 14).

A mold of a shaping machine equipped with an electromagnet was filled with the fine powder in nitrogen atmosphere. While being oriented under a magnetic field of 15 kOe (1.19 MA/m), the powder was compression shaped under the pressure shown in Table 3 in a direction perpendicular to the magnetic field. The resulting compact was measured for density and strength, with the results shown in Table 3. The compact strength was measured by placing the compact in a glove box, forcing a push-pull gauge against the compact, and measuring the rupture pressure at the instant when the compact was cracked. The number of test samples was 8 or more. The value in Table 3 is the average of test data excluding the maximum and minimum. For the measurement of compact strength, a digital force gauge RZ-10 with motorized stand Model-2257 (by Aikoh Engineering Co., Ltd.) was used.

The compact, which was not used in the strength measurement, was sintered in vacuum at 1,050° C. for 3 hours, cooled below 200° C., heat treated at a high temperature of 900° C. for 2 hours and heat treated at a low temperature of 500° C. for 3 hours, yielding a sintered body.

A parallelopiped block (sintered magnet) of 18 mm by 15 mm by 12 mm was cut out from a central portion of the sintered body, Magnetic properties (Br) of the sintered magnet were measured by a B—H tracer. Table 3 tabulates the values of Examples 11 to 13 and Comparative Examples 12 to 14.

TABLE 3

| | | | Shaping | Compact | Compact | |
|---|---|---|---|---|---|---|
| | | | pressure | density | strength | Br |
| | | Lubricant | (kN) | (g/cm³) | (N) | (T) |
| Example | 11 | menthol | 8 | 3.1 | 21 | 1.476 |
| | 12 | menthol | 10 | 3.3 | 38 | 1.472 |
| | 13 | menthol | 15 | 3.5 | 53 | 1.466 |
| Comparative | 12 | lauric acid | 8 | 3.4 | 12 | 1.466 |
| Example | 13 | lauric acid | 10 | 3.6 | 19 | 1.460 |
| | 14 | lauric acid | 15 | 3.8 | 27 | 1.455 |

As seen from Examples 11 to 13 in Table 3, the compact using menthol as the lubricant shows a high strength even when its density is low. Then, the compact is unsusceptible to crack and chipping during handling, an improvement in shaping yield is expectable, and a high value of Br is available, By contrast, the magnet of Comparative Example 12 shows a high value of Br comparable to Examples, but the compact is difficult to handle because of a low strength and undesirably low in shaping yield.

Japanese Patent Application No. 2021-080801 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A rare earth sintered magnet comprising R, Fe, and B wherein R is at least one element selected from rare earth elements, essentially including Nd, the magnet having a carbon concentration of 800 to 1,400 ppm, an oxygen concentration of up to 1,000 ppm, and a nitrogen concentration of up to 800 ppm, an average crystal grain size D50 (μm) of up to 4.5 μm, which is defined as an area average of the diameters of circles equivalent to crystal grains in a plane parallel to the magnetization direction, and a degree of orientation Or (%) which is defined by the formula (1) as a function of a remanence Br and a saturated magnetic flux density 4πIs,
Or=(Br/4πIs)*100 (1),
wherein D50 and Or meet the relationship of formula (2):
Or>0.7*D50+95 (2).

2. The rare earth sintered magnet of claim 1, further comprising 0.05 to 0.5 atom % of X which is at least one element selected from Ti, Zr, Hf, Nb, V, and Ta, wherein the relationship of formula (3):
4.3<[B]−2[X]<5.5 (3)
is fulfilled wherein [B] is atom % of B and [X] is atom % of X.

3. The rare earth sintered magnet of claim 1 wherein the content of R is 12.5 to 15.0 atom %.

4. The rare earth sintered magnet of claim 1 wherein R contains more than 0% to 1% by weight of at least one element selected from Dy, Tb, Gd, and Ho.

5. The rare earth sintered magnet of claim 1 wherein element R which is introduced into the magnet after sintering by grain boundary diffusion is included as part of R.

6. A method for preparing a rare earth sintered magnet, comprising the steps of finely pulverizing a coarse alloy powder into a fine powder, the alloy containing R, Fe, and B, shaping the fine powder under a magnetic field into a compact, and heat treating the compact into a sintered body, wherein
the finely pulverizing step includes adding a compound having a polar functional group and a cyclohexane skeleton to the coarse alloy powder to provide a source powder, and finely pulverizing the source powder in an inert gas atmosphere to an average particle size of 0.5 to 3.5 μm, which is a median diameter in a volume basis particle size distribution as measured by the laser diffraction scattering method.

7. The method of claim 6 wherein the compound having a polar functional group and a cyclohexane skeleton has a molecular weight of up to 250.

8. The method of claim 6 wherein the compound having a polar functional group and a cyclohexane skeleton is added in an amount of 0.08 to 0.3 parts by weight per 100 parts by weight of the coarse alloy powder.

9. The method of claim 6 wherein the rare earth sintered magnet prepared has an oxygen concentration of up to 1,000 ppm.

10. The method of claim 6 wherein the rare earth sintered magnet prepared has a nitrogen concentration of up to 800 ppm.

11. The method of claim 6 wherein the polar functional group is OH, COOH, CH₃COO or NH₂.

12. The method of claim 6 wherein the compact has a density of 2.8 to 3.6 g/cm³.

13. The method of claim 6 wherein the compact has a strength of at least 20 N as measured by forcing a push-pull gauge to the compact and reading the force of the gauge at which the compact is cracked.

14. The method of claim 6 wherein the compound having a polar functional group and a cyclohexane skeleton has a vapor pressure of up to 15 Pa at 25° C.
